(19) United States
(12) Patent Application Publication
(10) Pub. No.: US 2011/0248568 A1
(43) Pub. Date: Oct. 13, 2011

(54) ENERGY STORAGE DEVICE POWER SLEEP MODE

(75) Inventors: Keith Morgan, St. Albans (GB); Daniel V. Marquez, Welwyn Garden City (GB)

(73) Assignee: XEROX CORPORATION, Norwalk, CT (US)

(21) Appl. No.: 12/758,216

(22) Filed: Apr. 12, 2010

(51) Int. Cl. H02J 4/00

(52) U.S. Cl. 307/75; 307/80

(57) ABSTRACT

In methods and apparatuses at least one power supply is connected to at least one functional component. The power supply is also connected to an alternating current power source. The power supply provides power to the functional component when the functional component is operating in a relatively high power mode (normal operating mode). In addition, at least one energy storage device is connected to the functional component. The energy storage device supplies energy storage device power to the functional component when the functional component is operating in a relatively low power mode, such as a sleep mode.

### BACKGROUND AND SUMMARY

Embodiments herein generally relate to devices that have higher power modes (normal operating nodes) and lower power modes (e.g., low power modes, sleep modes, etc.) and more particularly to an apparatus that reduces power consumption during sleep mode by utilizing battery power during sleep mode.

Modern machines are required to have very low power consumption in sleep modes. As is understood by those ordinarily skilled in the art, many of today's devices have the ability to operate at multiple power levels. For example, some devices can operate normally at a high-power level to provide superior performance, and after some level of inactivity, can automatically switch to a lower power level to conserve energy. There can be various stages of lower power levels. Thus, the device can transition from high-power to low power if a certain period of inactivity (e.g., 5 minutes) has expired since the device has been utilized. This lower power state may be one in which the recovery time to full power is very short (1-10 seconds).

An even lower power state can be utilized after longer period of inactivity (e.g., 10 minutes). These additional lower power states are sometimes referred to as “sleep” power states because power is not supplied to most of the components and, instead, power is only supplied to a very limited amount of circuitry. This limited amount of circuitry has the ability to receive an input signal to return to a higher power state, and the ability to cause the devices that have been powered down to repower. One disadvantage of sleep power states is that they may have a much longer recovery time to full power (30 seconds-2 minutes). While some devices have multiple power states, other devices only have high power and sleep states. Irrespective, the embodiments herein apply to all such devices.

More stringent energy efficiency regulations are requiring designs to move towards much lower sleep mode power usage. This increases the differential between peak power loads required in normal operational mode and very low power loads required in sleep mode. Power supply efficiencies vary with load. Power supply efficiencies are typically most efficient between (50-75% rated load) but fall off at high and low loads. Therefore, using a single supply to power normal operations and sleep modes leads to increasing variation in power supply efficiency between modes. The embodiments herein circumvent inefficiency at the very low load required in sleep mode by utilizing a battery.

Sleep modes are one of many factors that must be considered in the electrical design in order to comply with internationally recognized energy efficiency standards. This low power requirement is typically met by either a dedicated sleep mode power supply or via provision of direct current (DC) power supplied from the alternating current (AC) inlet socket via internal voltage converters within the power supplies and individual controller boards. These power reducing devices add complexity, add cost for a dedicated supply and/or are inefficient at such low currents resulting in much higher outlet power consumption during sleep mode than desired.

The embodiments herein provide the power required to support sleep mode directly to the electronics board via batteries. This approach avoids the need for a dedicated sleep mode power supply, the need for very high efficiency power converters and has beneficial side-effects such as significant reductions in total energy consumption and resilience against brown outs and power outages during sleep periods.

One broad apparatus embodiment herein includes at least one functional component (that requires power to operate) and at least one power supply connected to the functional component. The power supply is also connected to an alternating current power source and converts the power supplied from the power source into a form required by the functional component. The power supply provides power to the functional component when the functional component is operating in a relatively high power mode (normal operating mode). In addition, at least one battery is connected to the functional component. The battery supplies battery power to the functional component when the functional component is operating in a relatively low power mode, such as an intermediate lower power state or sleep mode.

As mentioned above, some devices that are always connected to an alternating current power source (non-portable devices) usually include dedicated sleep mode power supply assemblies or internal voltage converters that are utilized to supply a reduced amount of power to the functional components during sleep mode. However, by utilizing a battery to power the functional component during sleep mode, the embodiments herein avoid the need for expensive and complicated components such as dedicated sleep mode power supplies, internal voltage converters, etc. In other words, with embodiments herein, the power supply does not provide power to the functional component during sleep mode; instead, the battery supplies power during sleep mode. By eliminating such expensive and complicated components, the embodiments herein simplify the apparatus, make the apparatus lighter, less expensive, more energy efficient and more reliable.

With some embodiments herein, the battery is utilized as the exclusive power supply for the functional component when operating in low power mode, and the battery can be only utilized during low power mode operations. Thus, in some embodiments herein, the battery is designed to provide the lower voltage that corresponds to the voltage required during the low power mode (during sleep mode) and the battery would be incapable of supplying a sufficient amount of power for the functional components to operate in normal high-power mode.

Further, some embodiments herein are intended to be utilized with non-portable devices that perform normal high-power operations only when connected to an alternating current power source. Thus, when the functional component is operating in the low power mode, the power supply is still connected to and receiving power from the alternating current power source, but the power supply does not supply power to the functional component. Instead, as explained above, only the battery supplies power during low power mode operation. Similarly, when the functional component is operating in the high power mode, the battery does not supply the battery power to the functional component.

The “low power mode” comprises a non-operational sleep mode in which the battery supplies the battery power only to components of the functional component that wait for instructions to begin operating in the high power state. Also, the battery can be connected to the power supply and can be recharged by the power supply when the battery reaches a predetermined discharge level. It is most efficient to recharge the battery when the device is operating in the normal high power mode; however, for some devices and some situations, it may be possible to re-charge the battery when in low power mode (even though this is far less efficient).

While a generalized embodiment is summarized above, more specific embodiments herein can include a printing apparatus that has at least one media path that supplies sheets of media. In such embodiments, at least one marking engine places marks on the sheets of media. Further, at least one power supply is connected to the marking engine and is connected to an alternating current power source. The power supply provides power to the marking engine when the marking engine is operating in a relatively high power mode.

However, again rather than using a dedicated sleep mode power supply or internal voltage converters, this printing apparatus embodiment uses at least one battery connected to the marking engine, where the battery supplies battery power to the marking engine when the marking engine is operating in a relatively low power mode.

Similarly, when the marking engine is operating in the low power mode, the power supply is connected to the alternating current power source and does not supply power to the marking engine. Also, when the marking engine is operating in the high power mode, the battery does not supply the battery power to the marking engine. Again, the battery can be connected to the power supply and be recharged by the power supply when the battery reaches a predetermined discharge level.

Further embodiments herein include methods. One such method can supply sheets of media to at least one media path, place marks on the sheets of media using at least one marking engine. Such methods provide power to the marking engine when the marking engine is operating in a relatively high power mode using at least one power supply connected to the marking engine and connected to an alternating current power source. Also, such embodiments supply battery power to the marking engine when the marking engine is operating in a relatively low power mode using at least one battery connected to the marking engine.

As in the previous embodiments, in the method embodiments, when the marking engine is operating in the low power mode, the power supply is connected to the alternating current power source and does not supply power to the marking engine. When the marking engine is operating in the high power mode, the battery does not supply the battery power to the marking engine. Also, the method can further recharge the battery using the power supply when the battery reaches a predetermined discharge level.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a schematic diagram of a device according to embodiments herein;

FIG. 2 is a schematic diagram of a device according to embodiments herein;

FIG. 3 is a flow diagram illustrating embodiments herein;

FIG. 4 is a schematic diagram illustrating low efficiency sleep mode power conversion;

FIG. 5 is a schematic diagram illustrating high efficiency sleep mode power conversion; and

FIG. 6 is a schematic diagram illustrating sleep mode power supplied through a battery.

### DETAILED DESCRIPTION

As mentioned above, the embodiments herein provide the power required to support sleep mode directly to the electronics board via batteries. This approach avoids the need for a dedicated sleep mode power supply, and the need for very high efficiency power converters and has beneficial side-effects such as significant reductions in total energy consumption and resilience against brown outs and power outages during sleep mode.

While the term battery is sometimes used as an exemplary energy storage device in the description herein, those ordinarily skilled in the art would understand that the embodiments herein are not limited to battery power. Instead, any form of energy storage device, including capacitor-based, chemically-based, physically-based energy storage devices, etc., (whether currently known or developed in the future) could be used with the embodiments herein. Therefore, when the term battery or energy storage device is mentioned in this disclosure, it is intended to include all such devices.

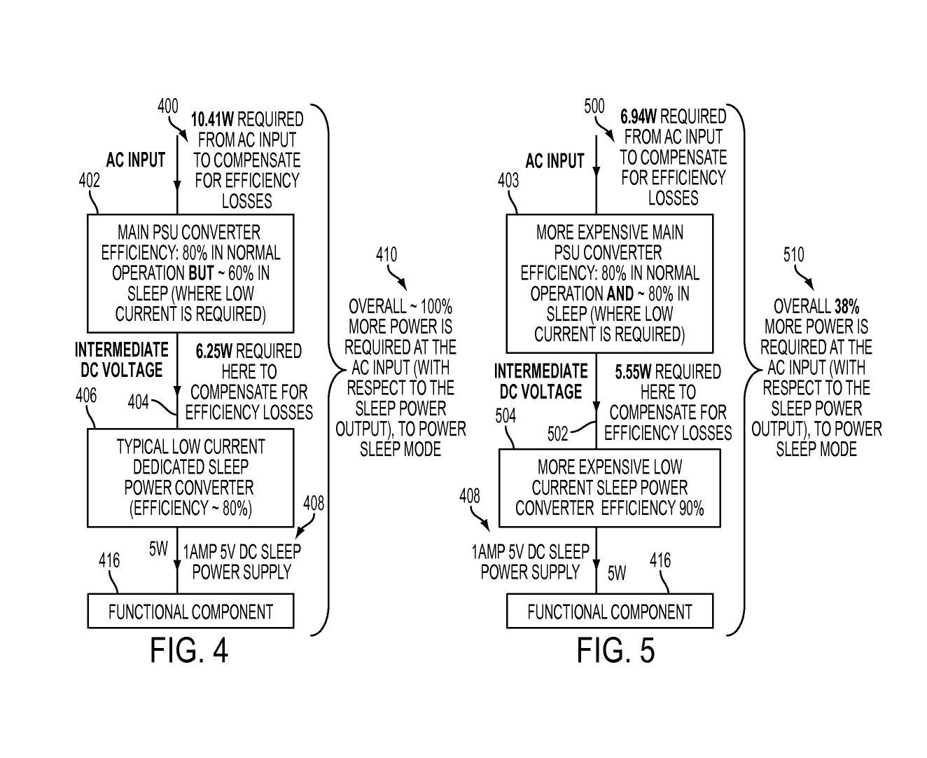

To use a multi-function printing apparatus as an example, power is converted from AC (110v, 220v, etc.) at the power inlet to an intermediate DC voltage supply and then further converted to 5v at the controller board to supply the components that are required to remain awake in sleep mode. For typical power conversion efficiencies of 80% and 60% in a two step conversion process (see FIG. 4), requires 10.41 W DC at source to provide 5 W DC to the controller board for sleep.

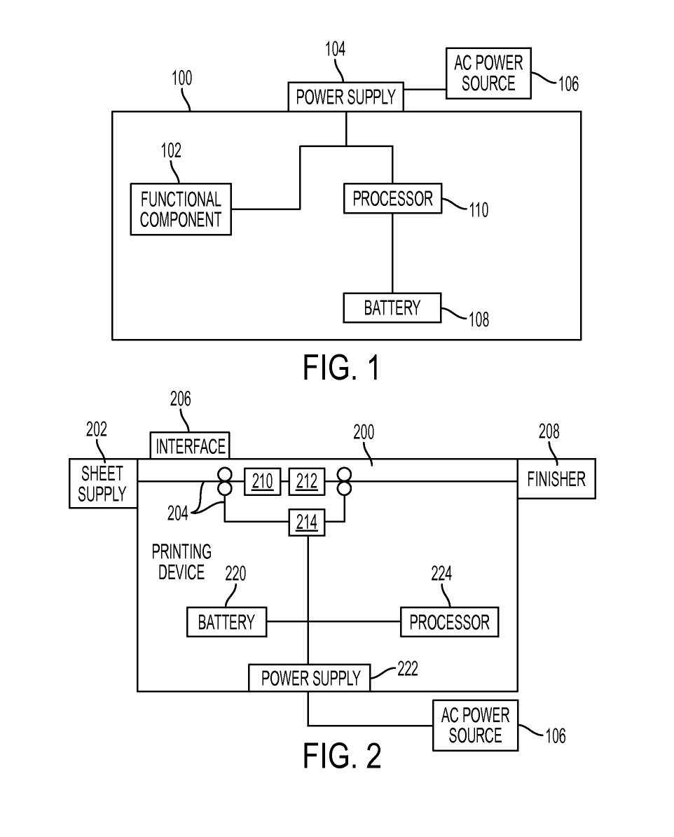

One broad apparatus embodiment that is illustrated in FIG. 1 comprises an apparatus 100 that includes at least one functional component 102 (that requires power to operate) and at least one power supply 104 connected to the functional component 102. In addition, the processor 110 can be connected to the various components mentioned herein to control the operations of the apparatus 100. This apparatus 100 can comprise any device that requires electrical power to operate, and can include computerized devices, mechanical devices, portable devices, non-portable devices, residential devices, commercial devices, etc.

The power supply 104 is also connected to an alternating current power source 106 (110v, 220v, single phase power, three phase power, etc.) and converts the power supplied from the power source 106 into a form required by the functional component 102. For example, the power supply 106 could convert alternating current power to direct current power or could change the voltage level of the alternating current. Different functional components 102 will have different power requirements that the power supply 104 can fulfill.

The power supply 104 provides power to the functional component 102 when the functional component 102 is operating in a relatively high power mode (normal operating mode). In addition, at least one battery 108 is connected to the functional component 102. The battery 108 can comprise any form of battery (or battery pack) whether currently known or developed in the future including but not limited to, capacitors, lead acid batteries, nickel cadmium batteries, lithium ion batteries, etc see note. The battery 108 supplies battery power to the functional component 102 when the functional component 102 is operating in a relatively low power mode, such as a sleep mode.

As mentioned above, some devices that are always connected to an alternating current power source 106 (e.g., non-portable devices) usually include dedicated sleep mode power supply assemblies or internal voltage converters that are utilized to supply a reduced amount of power to the functional components 102 during sleep mode. However, by utilizing a battery 108 to power the functional component 102 during sleep mode, the embodiments herein avoid the need for expensive and complicated components such as dedicated sleep mode power supplies, internal voltage converters, etc. In other words, with embodiments herein, the power supply 104 does not provide power to the functional component 102 during sleep mode; instead, the battery 108 supplies power during sleep mode. By eliminating such expensive and complicated components, the embodiments herein simplify the apparatus; make the apparatus lighter, less expensive, more energy efficient and more reliable.

With some embodiments herein, the battery 108 is utilized as the exclusive power supply 104 for the functional component 102 when operating in low power mode, and the battery 108 can be only utilized during low power mode operations. Thus, in some embodiments herein, the battery 108 is designed to provide the lower voltage that corresponds to the voltage required during the low power mode (during sleep mode) and the battery 108 would be incapable of supplying a sufficient amount of power for the functional components 102 to operate in normal high-power mode.

Further, some embodiments herein are intended to be utilized with non-portable devices that perform normal high-power operations only when connected to an alternating current power source 106. Thus, when the functional component 102 is operating in the low power mode, the power supply 104 is still connected to and receiving power from the alternating current power source 106, but the power supply 104 does not supply power to the functional component 102. Instead, as explained above, only the battery 108 supplies power during low power mode operation. Similarly, when the functional component 102 is operating in the high power mode, the battery 108 does not supply the battery 108 power to the functional component 102.

The “low power mode” as used herein can be either a lower-power, quick recovery mode, or a non-operational sleep mode in which the battery 108 supplies the battery 108 power only to elements of the functional component 102 that wait for instructions to begin operating in the high power state. Also, the battery 108 can be connected to the power supply 104 and can be recharged by the power supply 104 when the battery 108 reaches a predetermined discharge level.

While a generalized embodiment is summarized above, more specific embodiments herein can include a printing apparatus such as the one illustrated in FIG. 2. This printing apparatus 200 can comprise any form of printing apparatus, including a liquid ink based printer, solid ink based printer, powder toner based printer, ink jet printer, laser printer, as well as any other form of printing device whether currently known or developed in the future. Further, the printing apparatus 200 can comprise a standalone printer, a multifunction device, a copier, etc.

This printing device 200 has at least one media path 204 that supplies sheets of media from a sheet supply storage 202. In such embodiments, at least one marking engine 210, 214 places marks on the sheets of media and at least one fuser assembly 212 fuses the marks to the sheets of media. Once the marks are printed on the sheets of media, a finisher 208 can be utilized to perform various functions including sorting, stapling, folding, bookmaking, etc. A processor 224 controls the various operations of the printing device 200. For example, the processor 224 can include a computer storage device (magnetic memory, electronic memory, etc.) that stores a program of instructions that is executed by the processor to perform the various methods and processes described herein.

Further, at least one power supply 222 is connected to the marking engine 210, 214 and is connected to the alternating current power source 106. The power supply 222 provides power to the marking engine 210, 214 when the marking engine 210, 214 is operating in a relatively high power mode. However, again rather than using a dedicated sleep mode power supply or internal voltage converters, this printing apparatus embodiment uses at least one energy storage device 220 connected to the marking engine 210, 214, where the energy storage device 220 supplies power to the marking engine 210, 214 when the marking engine 210, 214 is operating in a relatively low power mode.

The marking engine 210, 214 includes physical and software actuators, and circuitry. Further, some marking engines 210, 214 (or marking engine assemblies) can be considered to include the power supply 222. When in normal operating mode (relatively high-power mode) the circuitry, actuators, etc., receives power from the power supply 222. However, when in low power or sleep mode the actuators, etc., do not receive any power from any device and only the circuitry receives power, and the circuitry receives such power only from the energy storage device 220. Therefore, with embodiments herein, during sleep mode, no power is drawn from the power supplied 222.

Also, while the marking engine 210, 214 is mentioned in this example as receiving only battery power during sleep mode, any other element within the printing device 200 could similarly only receive battery power during sleep mode. Each such device could include a dedicated battery or multiple batteries could be utilized within the printing device 200. Therefore, the illustration of item 220 can represent a single battery or multiple batteries, depending upon implementation.

Thus, when the marking engine 210, 214 is operating in the low power mode, the power supply 222 is connected to the alternating current power source and does not supply the first power to the marking engine 210, 214. Also, when the marking engine 210, 214 is operating in the high power mode, the energy storage device 220 does not supply the battery power to the marking engine 210, 214. Again, the energy storage device 220 can be connected to the power supply 222 and be recharged by the power supply 222 when the energy storage device 220 reaches a predetermined discharge level.

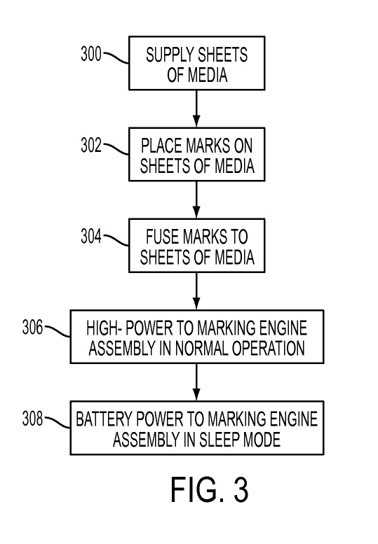

Further embodiments herein include methods, one of which is illustrated in flowchart form in FIG. 3. This exemplary method can supply sheets of media to at least one media path in item 300. Then, in item 302, this method places marks on the sheets of media using at least one marking engine, and fuse the marks to the sheets of media using at least one fuser assembly in item 304.

The exemplary method provides power to the marking engine (item 306) when the marking engine is operating in a relatively high power mode using at least one power supply connected to the marking engine and connected to an alternating current power source. Also, such embodiments supply battery power to the marking engine when the marking engine is operating in a relatively low power mode using at least one battery connected to the marking engine (item 308).

FIG. 4 is a schematic diagram illustrating a low efficiency power converter utilization process. As shown in item 400, alternating current is input to the main power supply converter 402 which has a conversion efficiency of 80% in normal operation and 60% in sleep mode (where low current is required). Energy from the power supply unit 402 is delivered to the relatively inexpensive low current dedicated sleep power converter 406, which has an 80% efficiency. The 1 Amp 5 V direct current sleep power supply is output from the low current dedicated sleep power converter 406.

In FIG. 4, 10.41 W is required from the alternating current input to compensate for efficiency losses as shown in item 400. As shown in item 404, 6.25 W is required to compensate for the efficiency losses of the sleep power converter 406. Thus, as shown in item 410, overall 100% more power is required at the AC input (with respect to the sleep power output) to provide power to the functional component 416 in sleep mode.

A similar schematic diagram is shown in FIG. 5; however, in FIG. 5, Higher efficiency (and more expensive) power converters 403, 504 are utilized. 6.94 W is required from the alternating current input to compensate for efficiency losses as shown in item 500. As shown by item 502, this higher efficiency power converter 504 needs less power (5.55 W) to compensate for the efficiency losses of the sleep power converters 504 when compared to those shown in item 404 in FIG. 4. Thus as show in item 510, overall 38% more power is required at the AC input (with respect to the sleep power output) to provide power in sleep mode.

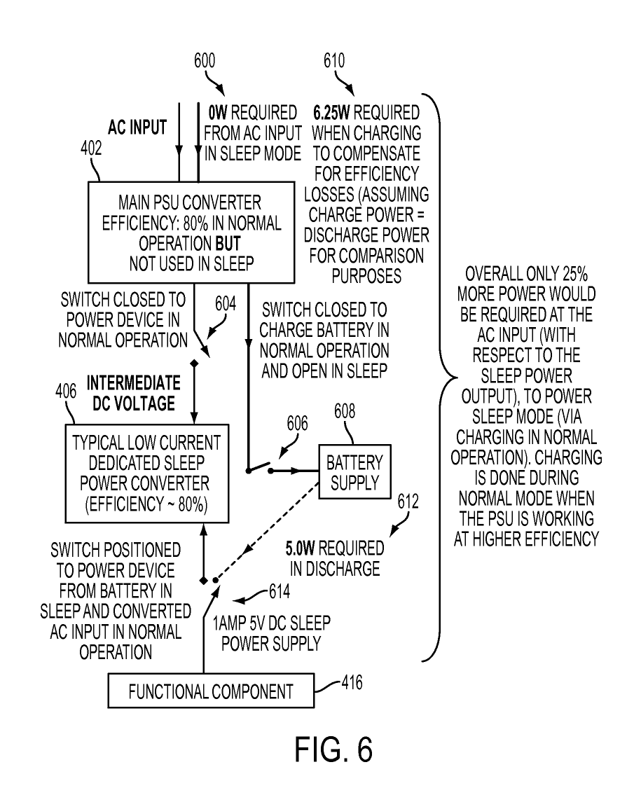

FIG. 6 illustrates a schematic diagram that uses an energy storage device or battery as discussed above and FIG. 6 is shown in the battery supply sleep mode configuration. Therefore item 600 shows 0 W being required from the AC input in the sleep mode. Thus as show in item 610, overall 38% more power is required at the AC input (with respect to the sleep power output) to provide power in sleep mode.

More specifically, in the sleep mode shown in FIG. 6, switch 604 is open to disconnect the main power supply unit 402 from the relatively low efficient sleep power converter 406. Similarly, switch 606 is open disconnecting the main power supply unit 402 from the battery 608 in sleep mode as the battery 608 is generally only charged during normal high power operation. In sleep mode, switch 614 is closed to allow the battery 608 to supply the functional component 616 with energy. Item 612 shows that only 5 W is required for the functional component 416.

Because of the use of the battery 608, overall only 25% more power would be required at the AC input 600 (with respect to the sleep power output) to power sleep mode. Again, recharging of the battery 608 is done during normal mode operation when the power supply unit 600 is working at higher efficiency (although contingencies can be established for charging the battery during sleep mode if the battery becomes fully discharged while in sleep mode).

Thus, when the marking engine is operating in the low power mode, the power supply is connected to the alternating current power source and does not supply power to the marking engine. When the marking engine is operating in the high power mode, the energy storage device does not supply the energy storage device power to the marking engine. Also, the method can further recharge the energy storage device using the power supply when the energy storage device reaches a predetermined discharge level. It is most efficient to recharge the battery when the device is operating in the normal high power mode; however, for some devices and some situations, it may be possible to re-charge the battery when in low power mode (even though this is far less efficient).

Software included within the energy storage device can be supplied to the controller to ensure that sleep mode power consumption from the AC inlet is maintained within predetermined limits. There are also cost benefits, as batteries and charger circuit are less expensive than dedicated voltage converters.

With embodiments herein, low power and sleep modes operate by switching to energy storage device power at mode transition from low power to sleep. The energy storage device charge levels are monitored by the controller and charging is performed during Ready/Run and Low power modes. At entry to sleep the controller logic can check the energy storage device status.

This energy storage device powered sleep mode essentially stores energy during ready and low power modes for use during sleep mode. The capacity of the energy storage device power pack and the single board controller sleep mode power consumption determine the length of time for which sleep mode can be sustained without needing to draw power from the AC inlet.

When running in energy storage device sleep mode, any brown outs or power outages will not affect the machine and the machine will not find itself powered down after a short outage. Further, with embodiments herein, when in energy storage device sleep mode, the devices are resilient to the transient loss of AC system power that ordinarily would cause a power down cycle. Therefore, the embodiments herein avoid unnecessary and lengthy power up/warm-up period before the machine can be used again.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. An apparatus comprising:
at least one functional component;
at least one power supply connected to said functional component and connected to an alternating current power source, said power supply providing first power to said functional component when said functional component is operating in a relatively high power mode; and
at least one energy storage device connected to said functional component, said energy storage device supplying energy storage device power to said functional component when said functional component is operating in a relatively low power mode.

2. The apparatus according to claim 1, when said functional component is operating in said low power mode, said power supply is connected to said alternating current power source and does not supply said first power to said functional component.

3. The apparatus according to claim 1, when said functional component is operating in said high power mode, said energy storage device does not supply said energy storage device power to said functional component.

4. The apparatus according to claim 1, said low power mode comprising a non-operational sleep mode in which said energy storage device supplies said energy storage device power only to components that wait for instructions to begin operating in said high power state.

5. The apparatus according to claim 1, said energy storage device further being connected to said power supply and being recharged by said power supply when said energy storage device reaches a predetermined discharge level.

6. A printing apparatus comprising:
at least one media path supplying sheets of media;
at least one marking engine placing marks on said sheets of media;
at least one power supply connected to said marking engine and connected to an alternating current power source, said power supply providing first power to said marking engine when said marking engine is operating in a relatively high power mode; and
at least one energy storage device connected to said marking engine, said energy storage device supplying energy storage device power to said marking engine when said marking engine is operating in a relatively low power mode.

7. The printing apparatus according to claim 6, when said marking engine is operating in said low power mode, said power supply is connected to said alternating current power source and does not supply said first power to said marking engine.

8. The printing apparatus according to claim 6, when said marking engine is operating in said high power mode, said energy storage device does not supply said energy storage device power to said marking engine.

9. The printing apparatus according to claim 6, said low power mode comprising a non-operational sleep mode in which said energy storage device supplies said energy storage device power only to components that wait for instructions to begin operating in said high power state.

10. The printing apparatus according to claim 6, said energy storage device further being connected to said power supply and being recharged by said power supply when said energy storage device reaches a predetermined discharge level.

11. A marking engine assembly comprising:
at least one marking engine making marks on sheets of media;
at least one power supply connected to said marking engine and connected to an alternating current power source, said power supply providing first power to said marking engine when said marking engine is operating in a relatively high power mode; and
at least one energy storage device connected to said marking engine, said energy storage device supplying energy storage device power to said marking engine when said marking engine is operating in a relatively low power mode.

12. The marking engine assembly according to claim 11, when said marking engine is operating in said low power mode, said power supply is connected to said alternating current power source and does not supply said first power to said marking engine.

13. The marking engine assembly according to claim 11, when said marking engine is operating in said high power mode, said energy storage device does not supply said energy storage device power to said marking engine.

14. The marking engine assembly according to claim 11, said low power mode comprising a non-operational sleep mode in which said marking engine supplies said energy storage device power only to components that wait for instructions to begin operating in said high power state.

15. The marking engine according to claim 11, said energy storage device further being connected to said power supply and being recharged by said power supply when said energy storage device reaches a predetermined discharge level.

16. A method comprising:
supplying sheets of media to at least one media path;
placing marks on said sheets of media using at least one marking engine;
providing first power to said marking engine when said marking engine is operating in a relatively high power mode using at least one power supply connected to said marking engine and connected to an alternating current power source; and
supplying energy storage device power to said marking engine when said marking engine is operating in a relatively low power mode using at least one energy storage device connected to said marking engine.

17. The method according to claim 16, when said marking engine is operating in said low power mode, said power supply is connected to said alternating current power source and does not supply said first power to said marking engine.

18. The method according to claim 16, when said marking engine is operating in said high power mode, said energy storage device does not supply said energy storage device power to said marking engine.

19. The method according to claim 16, said low power mode comprising a non-operational sleep mode in which said energy storage device supplies said energy storage device power only to components that wait for instructions to begin operating in said high power state.

20. The method according to claim 16, said energy storage device further being connected to said power supply, said method further comprising recharging said energy storage device using said power supply when said energy storage device reaches a predetermined discharge level.
